(19) United States
(12) Patent Application Publication
(10) Pub. No.: US 2021/0326659 A1
(43) Pub. Date: Oct. 21, 2021

(54) SYSTEM AND METHOD FOR UPDATING AN INPUT/OUTPUT DEVICE DECISION-MAKING MODEL OF A DIGITAL ASSISTANT BASED ON ROUTINE INFORMATION OF A USER

(71) Applicant: Intuition Robotics, Ltd., Ramat-Gan (IL)

(72) Inventors: Shay ZWEIG, Harel (IL); Alex KEAGEL, Tel Aviv (IL); Itai MENDELSOHN, Tel Aviv (IL); Roy AMIR, Mikhmoret (IL); Dor SKULER, Oranit (IL); Eldar RON, Tel Aviv (IL)

(73) Assignee: Intuition Robotics, Ltd., Ramat-Gan (IL)

(21) Appl. No.: 17/235,466

(22) Filed: Apr. 20, 2021

Related U.S. Application Data
(60) Provisional application No. 63/012,418, filed on Apr. 20, 2020.

(51) Int. Cl. G06K 9/62; G06N 3/04; G06N 20/00; G06T 1/00; G06F 3/01; G06K 9/00

(52) U.S. Cl. CPC G06K 9/6263; G06N 3/04; G06N 20/00; G06K 9/00369; G06F 3/011; G06K 9/00355; G06T 1/0014

(57) ABSTRACT

A system and method for updating an input/output device decision-making model of a digital assistant based on routine information of a user are provided. The method includes analyzing at least a first collected dataset to identify a routine information data feature and a confidence level associated with the routine information data feature, wherein the first collected dataset is a dataset associated with a user; updating the input/output (I/O) device decision-making model of the digital assistant to include the identified routine information data feature; and executing at least one plan via the updated digital assistant by causing the I/O device to output a signal for causing at least one action by an external system with respect to the outside world.

### CROSS-REFERENCE TO RELATED APPLICATIONS

This application claims the benefit of 63/012,418 filed on Apr. 20, 2020, the contents of which are hereby incorporated by reference.

### TECHNICAL FIELD

The disclosure generally relates to digital assistants and, more specifically, to a system and method for updating an input/output device decision-making model of a digital assistant based on routine information of a user.

### BACKGROUND

As manufacturers continue to improve electronic device functionality through the inclusion of processing hardware, users, as well as manufacturers themselves, may desire expanded feature sets to enhance the utility of the included hardware. Examples of technologies which have been improved, in recent years, by the addition of faster, more-powerful processing hardware include cell phones, personal computers, vehicles, and the like. As described, such devices have also been updated to include software functionalities which provide for enhanced user experiences by leveraging device connectivity, increases in processing power, and other functional additions to such devices. However, the software solutions described, while including some features relevant to some users, may fail to provide certain features which may further enhance the quality of a user experience.

Many modern devices, such as cell phones, computers, vehicles, and the like, include software suites which leverage device hardware to provide enhanced user experiences. Examples of such software suites include cell phone virtual assistants, which may be activated by voice command to perform tasks such as playing music, starting a phone call, and the like, as well as in-vehicle virtual assistants configured to provide similar functionalities. While such software suites may provide for enhancement of certain user interactions with a device, such as by allowing a user to place a phone call using a voice command, the same suites may fail to provide routine-responsive functionalities, thereby hindering the user experience. As certain currently-available user experience software suites for electronic devices may fail to provide routine-responsive functionalities, the same suites may be unable to identify, and adapt to, a user's daily routines, thereby requiring a user to repeat certain interactions with an electronic device, where the user, in view of the user's routine, may wish to have such interactions performed automatically, which may limit user experience quality.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a method for updating an input/output device decision-making model of a digital assistant based on routine information of a user. The method comprises: analyzing at least a first collected dataset to identify a routine information data feature and a confidence level associated with the routine information data feature, wherein the first collected dataset is a dataset associated with a user; updating the input/output (I/O) device decision-making model of the digital assistant to include the identified routine information data feature; and executing at least one plan via the updated digital assistant by causing the I/O device to output a signal for causing at least one action by an external system with respect to the outside world.

Certain embodiments disclosed herein also include a non-transitory computer readable medium having stored thereon instructions for causing a processing circuitry to execute a process, the process comprising: analyzing at least a first collected dataset to identify a routine information data feature and a confidence level associated with the routine information data feature, wherein the first collected dataset is a dataset associated with a user; updating the input/output (I/O) device decision-making model of the digital assistant to include the identified routine information data feature; and executing at least one plan via the updated digital assistant by causing the I/O device to output a signal for causing at least one action by an external system with respect to the outside world.

Certain embodiments disclosed herein also include a system for updating an input/output device decision-making model of a digital assistant based on routine information of a user. The system comprises: a processing circuitry; and a memory, the memory containing instructions that, when executed by the processing circuitry, configure the system to: analyze at least a first collected dataset to identify a routine information data feature and a confidence level associated with the routine information data feature, wherein the first collected dataset is a dataset associated with a user; update the input/output (I/O) device decision-making model of the digital assistant to include the identified routine information data feature; and execute at least one plan via the updated digital assistant by causing the I/O device to output a signal for causing at least one action by an external system with respect to the outside world.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a network diagram of a system utilized for updating an input/output device decision-making model of a digital assistant based on routine information of a user, according to an embodiment.

FIG. 2 is a block diagram of a controller, according to an embodiment.

FIG. 3 is a first flowchart illustrating a method for updating an input/output device decision-making model of a digital assistant based on routine information of a user, according to an embodiment.

FIG. 4 is a second flowchart illustrating a method for updating an input/output device decision-making model of a digital assistant based on routine information of a user, according to an embodiment.

### DETAILED DESCRIPTION

The embodiments disclosed by the disclosure are only examples of the many possible advantageous uses and implementations of the innovative teachings presented herein. In general, statements made in the specification of the present application do not necessarily limit any of the various claimed disclosures. Moreover, some statements may apply to some inventive features but not to others. In general, unless otherwise indicated, singular elements may be in plural and vice versa with no loss of generality. In the drawings, like numerals refer to like parts through several views.

The disclosure teaches a system and method for updating an input/output device decision-making model of a digital assistant based on routine information of a user. The routine information generally characterizes routine behavior of a user. A digital assistant, to which a plurality of sensors is communicatively connected, is adapted to collect and analyze a first dataset. After the first dataset is analyzed, routine information of the user may be determined. Then, the input/output device decision-making model of the digital assistant is updated with the routine information of the user, allowing the digital assistant to perform plans and actions based on the determined routine information of the user.

The systems and methods described herein provide for the identification of routine information, the revision of Input/Output (I/O) device decision-making models based on the identified routine information, and the execution of various plans, through I/O devices, based on the revised I/O device decision-making models. The systems and methods described herein provide for increased objectivity in such processes, when compared with the execution of such processes by a human actor. As a human actor may be limited to observation of routine information, without the capacity to attribute confidence ratings to such information and make assessments based thereupon, such human observations may be subjective. As the disclosed systems and methods provide for improved objectivity in identification of routine information, the subsequent updating of the I/O device decision-making model, and the execution of plans based thereupon, may similarly benefit from the improved objectivity of the systems and methods disclosed herein,

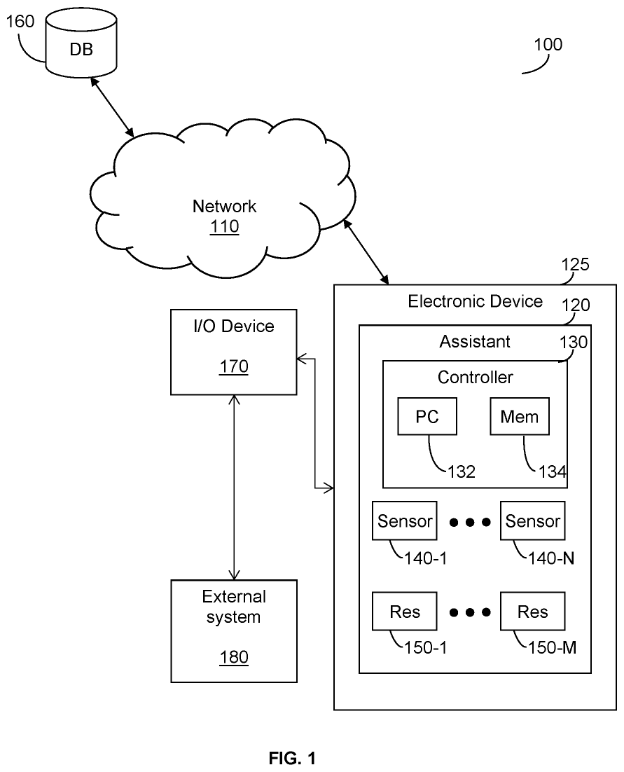

FIG. 1 is an example network diagram of a system 100 utilized for updating an input/output device decision-making model of a digital assistant, according to an embodiment. The system 100 includes a digital assistant 120 (assistant) and an electronic device 125, as well as an input/output (I/O) device connected to the electronic device 125, and an external system 180 connected to the I/O device 170. In some embodiments, the assistant 120 is further connected to a network, where the network 110 is used to communicate between different parts of the system 100. The network 110 may be, but is not limited to, a local area network (LAN), a wide area network (WAN), a metro area network (MAN), the Internet, a wireless, cellular or wired network, and the like, and any combination thereof.

In an embodiment, the digital assistant 120 may be connected to, or implemented on, the electronic device 125. The electronic device 125 may be, for example and without limitation, a robot, a social robot, a service robot, a smart TV, a smartphone, a wearable device, a vehicle, a computer, a smart appliance, and the like.

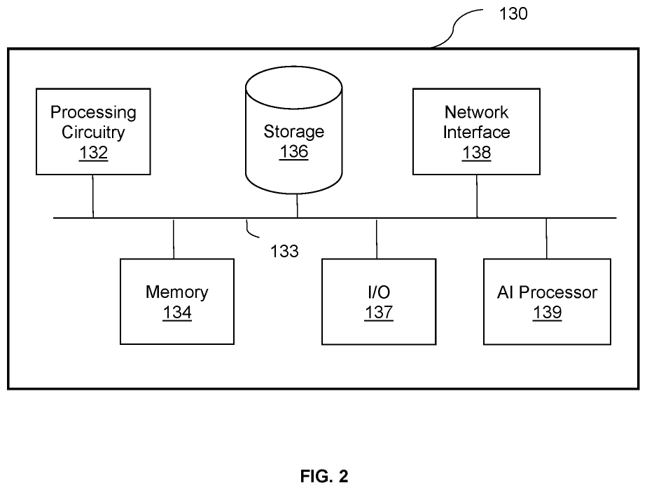

The digital assistant 120 includes a controller 130, explained in more detail below in FIG. 2, having at least a processing circuitry 132 and a memory 134. The digital assistant 120 may further include, or is connected to, one or more sensors 140-1 to 140-N, where N is an integer equal to or greater than 1 (hereinafter referred to as “sensor” 140 or “sensors” 140 for simplicity) and one or more resources 150-1 to 150-M, where M is an integer equal to or greater than 1 (hereinafter referred to as “resource” 150 or “resources” 150 merely for simplicity). The resources 150 may include, for example and without limitation, electro-mechanical elements, display units, speakers, and the like. In an embodiment, the resources 150 may encompass sensors 140 as well.

The sensors 140 may include input devices, such as, as examples and without limitation, various sensors, detectors, microphones, touch sensors, movement detectors, cameras, and the like. Any of the sensors 140 may be, but are not necessarily, communicatively or otherwise connected to the controller 130 (such connection is not illustrated in FIG. 1 merely for the sake of simplicity and without limitation on the disclosed embodiments). The sensors 140 may be configured to sense signals received from one or more users, the environment of the user (or users), and the like. The sensors 140 may be positioned on, or connected to, the electronic device 125 (e.g., a vehicle, a robot, and the like). In an embodiment, the sensors 140 may be implemented as virtual sensors which receive inputs from online services, e.g., the weather forecast.

The digital assistant 120 is configured to use the controller 130, the sensors 140, and the resources 150 for updating an input/output device decision-making model of the digital assistant 120 based on routine information of the user, as further discussed hereinbelow. For example, the digital assistant 120 may use one or more artificial intelligence (AI) algorithms for determining whether the routine information of the user is identified based on analyzing data and/or sensor data that is associated with the user, as further discussed hereinbelow.

In one embodiment, the system 100 further includes a database 160. The database 160 may be stored within the digital assistant 120 (e.g., within a storage device not shown), or may be separate from the digital assistant 120 and connected thereto via the network 110. The database 160 may be utilized for storing, for example, historical data about one or more users, historical routine information data features of the user, and the like, as further discussed hereinbelow with respect to FIG. 2.

The I/O device 170 is a device configured to generate, transmit, receive, or the like, as well as any combination thereof, one or more signals relevant to the operation of the external system 180. In an embodiment, the I/O device 170 is further configured to at least cause one or more outputs in the outside world (i.e., the world outside the computing components shown in FIG. 1) via the external system 180 based on plans determined by the assistant 120 as described herein.

The I/O device 170 may be communicatively connected to the electronic device 125 and the external system 180. It may be understood that while the I/O device 170 is depicted as separate from the electronic device 125, it may be understood that the I/O device may be included in the electronic device 125, or any component or sub-component thereof, without loss of generality or departure from the scope of the disclosure.

The external system 180 is a device, component, system, or the like, configured to provide one or more functionalities, including various interactions with external environments. The external system 180 is a system separate from the electronic device 125, although the external system 180 may be co-located with, and connected to, the electronic device 125, without loss of generality or departure from the scope of the disclosure. Examples of external systems 180 include, without limitation, air conditioning systems, lighting systems, sound systems, and the like.

As an example of the operation of the system described with respect to the network diagram, according to an embodiment, operation of the system may include generating one or more commands for controlling the external system, 180, where such commands are generated as described herein, by the assistant 120, and are executed by configuration of the I/O device 170 to send a control signal to the external system 180.

FIG. 2 shows a schematic block diagram of a controller 130 of a digital assistant, e.g., the digital assistant 120 of FIG. 1, according to an embodiment. The controller 130 includes a processing circuitry 132 that is configured to receive data, analyze data, generate outputs, and the like, as further described hereinbelow. The processing circuitry 132 may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The controller 130 further includes a memory 134. The memory 134 may contain therein instructions which, when executed by the processing circuitry 132, cause the controller 130 to execute actions as further described hereinbelow. The memory 134 may further store therein information, e.g., data associated with one or more users, historical data, historical data about one or more users, historical routine information data features of the user, and the like.

The storage 136 may be magnetic storage, optical storage, and the like, and may be realized, for example, as flash memory or other memory technology, compact disk-read only memory (CD-ROM), Digital Versatile Disks (DVDs), or any other medium which can be used to store the desired information.

In an embodiment, the controller 130 includes a network interface 138 that is configured to connect to a network, e.g., the network 110 of FIG. 1. The network interface 138 may include, but is not limited to, a wired interface (e.g., an Ethernet port) or a wireless port (e.g., an 802.11 compliant Wi-Fi card) configured to connect to a network (not shown).

The controller 130 further includes an input/output (I/O) interface 137, configured to control the resources 150 (shown in FIG. 1) which are connected to the digital assistant 120. In an embodiment, the I/O interface 137 is configured to receive one or more signals captured by sensors 140 of the assistant 120 and send the signals to the processing circuitry 132 for analysis. According to one embodiment, the I/O interface 137 is configured to analyze the signals captured by the sensors 140, detectors, and the like. According to a further embodiment, the I/O interface 137 is configured to send one or more commands to one or more of the resources 150 for executing one or more plans (e.g., actions) of the digital assistant 120, as further discussed hereinbelow. For example, a plan may include initiating a navigating plan, suggesting that the user activate an auto-pilot system of a vehicle, playing jazz music by a service robot, and the like. According to a further embodiment, the components of the controller 130 are connected via a bus 133.

In an embodiment, the controller 130 further includes an artificial intelligence (AI) processor 139. The AI processor 139 may be realized as one or more hardware logic components and circuits, including graphics processing units (GPUs), tensor processing units (TPUs), neural processing units, vision processing unit (VPU), reconfigurable field-programmable gate arrays (FPGA), and the like. The AI processor 139 is configured to perform, for example, machine learning based on sensory inputs received from the I/O interface 137, where the I/O interface 137 receives input data, such as sensory inputs, from the sensors 140. In an embodiment, the AI processor 139 is configured to at least determine routine information of the user as further discussed hereinbelow.

In an embodiment, the controller 130 collects at least a first dataset that is associated with at least a user of a digital assistant (e.g., the digital assistant 120). The first dataset may include, for example and without limitation, images, video, audio signals, historical data of the user, data from one or more web sources, and the like, as well as any combination thereof. In an embodiment, the collected first dataset may be related to the environment of the user. For example, environment data may include, without limitation, the temperature outside the user's house or vehicle, traffic conditions, noise level, number of people that are located in close proximity to the user, and the like. In an embodiment, at least a portion of the first dataset may be collected using a plurality of sensors (e.g., the sensors 140) which are communicatively connected to the digital assistant 120.

In an embodiment, the controller 130 applies at least one algorithm, such as a machine learning algorithm, to the at least a first dataset. The at least one algorithm may be adapted to determine routine information of the user based on the at least a first dataset. Applying the at least one algorithm may include analysis of the at least a first dataset. The analysis may be performed using, for example and without limitation, one or more computer vision techniques, audio signal processing techniques, machine learning techniques, and the like, as well as any combination thereof. For example, routine information data features may indicate that the user usually gets into his/her vehicle and starts driving to work on every weekday at 7:45 am, that the user is stressed when traffic is heavy, that the user usually likes to listen to Jazz music when he/she has company at home, and the like.

For example, the digital assistant operates in a user's vehicle. According to the same example, a first dataset (that includes historical and real-time data) is collected and indicates that the user is a known user, that the user usually listens to jazz music only when there is no one except the user in the vehicle, and that the user prefers to talk with his/her children when they are seated together in the vehicle. According to the same example, the first dataset may also include real-time data indicating that the user's children are in the vehicle. According to the same example, by applying the at least one algorithm to the first dataset, routine information data features relating to the user may be identified (e.g., indicating that the user prefers to talk with his/her children and not to be interrupted).

In an embodiment, the controller 130 updates an input/output (I/O) device decision-making model of the digital assistant 120 with the routine information. An I/O device decision-making model of the digital assistant 120 may include one or more artificial intelligence (AI) algorithms that are utilized for determining the actions to be performed by the digital assistant 120, including actions executed via the I/O device, actions executed via an external system, through the I/O device, and the like. Thus, when the routine information is determined, the routine information is fed into the I/O device decision-making model, thereby allowing the I/O device decision-making model to execute plans (e.g., actions) which suit the determined routine information data feature associated with the user. For example, referring to the aforementioned example, when identifying that the user and the user's children are in the vehicle, the I/O device decision-making model is updated with the determined routine information. Therefore, an action may be selected and executed by the controller 130, via the I/O device, as described, for preventing a suggestion to listen to music, such as through an external speaker system, or any other interaction with the user which may disturb the user.

In an embodiment, updating the I/O device decision-making model of the digital assistant 120 with the routine information may occur upon determination that a confidence level of the routine information is above a predetermined threshold value. The confidence level of the routine information may be determined based on one or more features that may be identified in the first dataset, the identification of the frequencies or numbers of occurrences of such features, and the application of one or more rules to such features. Features may refer to objects that were identified near the user, such as, as examples and without limitation, people, amounts of people, people's identities, pets, gestures made by the user, the amount of traffic in front of the user's vehicle, and the like, as well as any combination thereof.

For example, if it is previously determined that the user prefers to talk with other passengers when the passengers are in the vehicle and the user is not doing anything else, and, currently, only the user's spouse is identified in the vehicle, the confidence level of the routine information may be below the predetermined threshold. According to one embodiment, upon determination that the confidence level of the routine information is below the predetermined threshold, the controller 130 may be configured to perform an action. Such action may be, for example, generating at least one question to be presented by the digital assistant 120 to the user, using for example, one or more resources, e.g., the resources 150. According to another embodiment, the at least one question may be generated based on analysis of the collected first dataset. Then, a user response may be collected with respect to the presented question.

Collection of the user response may be achieved using the one or more sensors, such as the sensors 140. According to a further embodiment, the I/O device decision-making model of the digital assistant 120 may be updated based on the at least one response of the user. For example, an ambiguous routine information data feature may be identified such that the controller 130 generates a question to clarify the situation with the user. For example, the digital assistant 120 may ask the user: “do you wish to prevent all alerts, suggestions and recommendations when at least one person is with you in the vehicle?” As another example, when the digital assistant 120 operates as a service robot in the user's house, similar questions may be presented, such as: “do you wish to prevent all alerts, suggestions, and recommendations when at least one person is in the same room with you?” It should be noted that these examples, as well as other examples that are provided hereinabove and below, are non-limiting examples.

According to another example, the features that are extracted from the first dataset indicate that the user and the user's dog just entered the vehicle (in which the digital assistant 120 operates). According to the same example, by applying the at least one algorithm, the controller 130 determines that, due to the presence of the dog, a navigation plan to the veterinarian's clinic should be initiated. According to the same example, in 89% of the cases in which the dog was in the vehicle, the destination was the veterinarian's clinic, such that, when the dog is identified in the vehicle in real-time (based on analysis of the first dataset), the routine information data feature of the user is identified. According to the same example, and in case the confidence level of the routine information data feature of the user is below the predetermined threshold, (e.g., because the dog seems very active and the user mentions the word “park”), the digital assistant 120 may be configured to generate a question (e.g., the question may be: “are we going to the park or to the vet?”), to present the questions to the user, to collect the user response and to update the I/O device decision-making model of the digital assistant 120, respectively.

It should be noted that even when the confidence level of the routine information data feature is below the predetermined threshold value it may not be desirable to generate a question immediately or at all. Generating a question and presenting it to the user may be performed if the result of an analysis of real-time data of the user and the user's environment indicates that presenting a question to the user is acceptable, e.g., that the user will not be interrupted by the question.

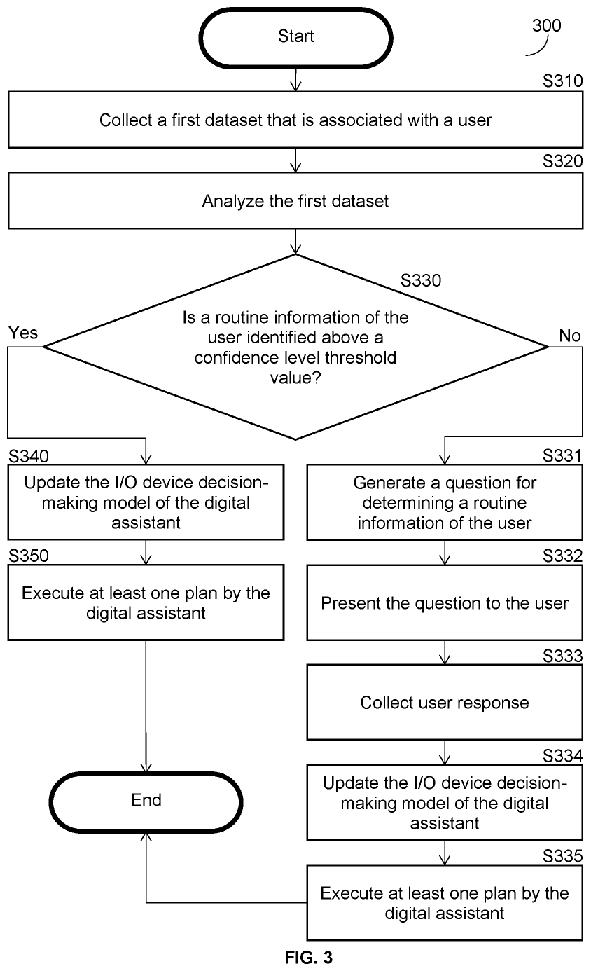

FIG. 3 shows a flowchart 300 of a method for updating an input/output device decision-making model of a digital assistant based on routine information of a user, according to an embodiment. The method described herein may be executed by the controller 130 that is further described hereinabove with respect of FIG. 2.

At S310, a first dataset is collected about a user of a digital assistant, e.g., the digital assistant 120 shown in FIG. 1. The user may be located within a predetermined distance from one or more sensors of the digital assistant 120. The data may include information about the user, historical data, sensor data, environmental data, and the like.

At S320, the first dataset is analyzed. The analysis of the first dataset may include applying at least one algorithm, such as a machine learning algorithm, to the first dataset. In an embodiment, the at least one algorithm may be adapted to determine routine information of the user, as further described hereinabove. In a further embodiment, the at least one algorithm may be adapted to determine a confidence level for the determined routine information data feature, as well as to determine whether a confidence level of the routine information data feature of the user is above a predetermined threshold value. The confidence level represents a certainty standard for distinguishing between cases where only suspected routine information is identified and cases where certain routine information of the user is identified. The first dataset may include features that may be extracted from the first dataset, thereby providing for determination of the circumstances near the user. The routine information includes behavioral patterns, habits, a routine schedule, and the like.

The features may refer to objects that were identified near the user, such as, as examples and without limitation, people, amounts of people, the identities of people, pets, gestures made by the user, amount of traffic in front of the user's vehicle, and the like. The extracted features may also refer to the weather parameters, time of day, and the like, as well as any combination thereof. In an embodiment, the analysis of the first dataset may be achieved using, for example and without limitation, one or more computer vision techniques, audio signal processing techniques, machine learning techniques, and the like, as well as any combination thereof.

At S330, it is determined whether the confidence level of the routine information data feature of the user is above the predetermined threshold value and, if so, execution continues with S340; otherwise, execution continues with S331. The determination may be achieved based on the result of the analysis of the first dataset.

At S340, an input/output (I/O) device decision-making model of the digital assistant 120 is updated with the routine information as further discussed hereinabove.

At the optional S350, a plan may be executed based on the updated I/O device decision-making model of the digital assistant (e.g., the digital assistant 120). A plan may include, for example and without limitation, initiating a navigation plan, automatically adjusting the car seat, suggesting that the user activate an auto-pilot system of a vehicle, playing music by a service robot, and the like.

In an embodiment, executing at least one plan based on the modified model, at S350, includes causing an input/output (I/O) device to output a signal in order to cause one or more interactions with the outside world (e.g., via an external system such as the external system 180, FIG. 1). An I/O device is a device, system, component, or the like, configured to interface between an information processing system (e.g., a computer) and the outside world. To this end, each I/O device may be configured to send or receive various signals to or from various external devices, components, or systems. The signal sent to, or received from, the various external devices may be a signal relevant to the operation of the external device, component, or system, such as, as examples and without limitation, commands, instructions, data readings, and the like.

At the optional S331, upon determination that the confidence level of the routine information is below the predetermined threshold value, a question is generated. The generated question is utilized for clarifying whether the first dataset indicates routine information of the user. The generation of the question may be achieved based on analyzing the first dataset as further discussed hereinabove. It should be noted that S331 may further include analyzing, in real-time, sensor data (e.g., of the first dataset) that may be collected from one or more sensors (e.g., the sensors 140) such that the controller 130 may be configured to determine whether presenting a question to the user is desirable or not. For, example, in the case where the result of the analysis indicates that the user is currently unhappy, the controller 130 may determine that a question shall not be presented to the user at the present moment. According to the same example, although presenting the question may not be desirable at the moment, the controller 130 may determine to postpone the presentation of the question to the user such that the question will be presented to the user when the user is, for example, relaxed, alone, or the like.

At the optional S332, the question is presented to the user using, for example, one or more resources (such as the resources 150). The presentation of the question may include verbal content as well as visual content (that may be represented on, e.g., a display), and the like.

When a question is presented to the user, at the optional S333, a response is collected to the presented question. It should be noted that the user response may be a gesture, a facial expression, a sentence, a single word, or the like, as well as any combination thereof.

Further, at optional S334, the I/O device decision-making model of the digital assistant is updated based on the user response. As described hereinabove, the I/O device decision-making model may be configured to provide for execution of one or more actions, via one or more I/O devices, based on one or more data features. Accordingly, where at least one user response is collected at S333, updating the I/O device decision-making model at S334 may include adding the at least one user response to the one or more data features for which the I/O device decision-making model is configured to execute the described actions.

At optional S335, a plan is executed based on the updated I/O device decision-making model of the digital assistant (e.g., the digital assistant 120) which is updated with the user response. A plan may include, for example and without limitation, initiating a navigation plan, automatically adjusting the car seat, suggesting that the user activate an auto-pilot system of a vehicle, playing music via a service robot, and the like, as well as any combination thereof, including plans executed via the I/O device.

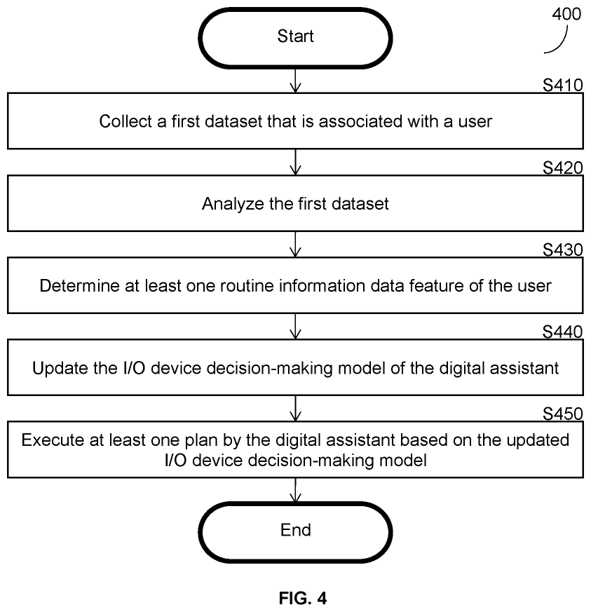

FIG. 4 shows an example flowchart 400 of a method for updating an input/output device decision-making model of a digital assistant based on routine information of a user, according to an embodiment. The method described herein may be executed by the controller 130 that is further described hereinabove with respect to FIG. 2.

At S410, a first dataset is collected about a user of a digital assistant, e.g., the digital assistant 120 shown in FIG. 1. The user may be located within a predetermined distance from one or more sensors of the digital assistant 120. The data may include information about the user, historical data, sensor data, environmental data, and the like.

At S420, the first dataset is analyzed. The analysis of the first dataset may include applying at least one algorithm, such as a machine learning algorithm, to the first dataset. In an embodiment, the at least one algorithm may be adapted to determine routine information of the user, as further described hereinabove. The first dataset may include features that may be extracted from the first dataset, thereby providing for determination of the circumstances near the user. The features may refer to objects that were identified near the user, such as, as examples and without limitation, people, amounts of people, people's identities, pets, gestures made by the user, the amount of traffic in front of the user's vehicle, and the like. The extracted features may also refer to the weather parameters, the time of day, and the like. In an embodiment, the analysis of the first dataset may be achieved using, for example and without limitation, one or more computer vision techniques, audio signal processing techniques, machine learning techniques, and the like, as well as any combination thereof.

At S430, routine information of the user is determined based on the analysis of the first dataset. Routine information may refer to habits the user may have, certain patterns, and the like, as well as any combination thereof. For example, routine information of the user may indicate that the user is stressed when traffic is heavy, that the user usually likes to listen to music when he/she is alone at home, and the like. In an embodiment, each determined routine information data feature may be associated with a corresponding confidence level score which may be determined using, for example, the at least one algorithm.

It should be noted that the confidence level score of each routine information data feature may be determined based on one or more features which may be identified in the first dataset. Features may refer to objects that were identified near the user, such as, as examples and without limitation, people, amounts of people, the identities of people, pets, gestures made by the user, amount of traffic in front of the user's vehicle, and the like, as well as any combination thereof. For example, if it is previously determined that the user prefers to talk with his/her children when the children are in the vehicle and the user is not doing anything else, and, currently, only the user's spouse is identified in the vehicle, the confidence level score of the routine information may be relatively low.

At S440, an I/O device decision-making model of the digital assistant 120 is updated with the routine information as further discussed hereinabove with respect to FIG. 2. In an embodiment, the update includes the determined routine information as well as the corresponding confidence level score of each routine information data feature.

At the S450, a plan may be executed based on the updated I/O device decision-making model of the digital assistant (e.g., the digital assistant 120). A plan may include, for example and without limitation, initiating a navigating plan, automatically adjusting the car seat, suggesting that the user activate an auto-pilot system of a vehicle, playing music by a service robot, and the like, as well as any combination thereof, including plans executed via one or more I/O devices. It should be noted that S450 may further include analyzing, in real-time, sensor data (e.g., of the first dataset) which may be collected from one or more sensors (e.g., the sensors 140) such that the controller (e.g., the controller 130) may be configured to determine whether it is desirable to execute a plan at the moment, at a different time, or when exactly, if at all, to execute the plan. For, example, in the case that the result of the analysis indicates that the user is arguing with someone, the controller (e.g., the controller 130) may determine that a plan should not be executed at the moment.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. AIso, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; 2A; 2B; 2C; 3A; A and B in combination; B and C in combination; A and C in combination; A, B, and C in combination; 2A and C in combination; A, 3B, and 2C in combination; and the like.

AIl examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for updating an input/output device decision-making model of a digital assistant based on routine information of a user, comprising:
analyzing at least a first collected dataset to identify a routine information data feature and a confidence level associated with the routine information data feature, wherein the first collected dataset is a dataset associated with a user;
updating the input/output (I/O) device decision-making model of the digital assistant to include the identified routine information data feature; and
executing at least one plan via the updated digital assistant by causing the I/O device to output a signal for causing at least one action by an external system with respect to the outside world.

2. The method of claim 1, further comprising:
determining whether the confidence level is above a threshold value.

3. The method of claim 2, wherein the input/output (I/O) device decision-making model of the digital assistant is updated to include the identified routine information data feature upon determination that the confidence level is above the threshold value.

4. The method of claim 1, further comprising:
collecting the first collected dataset from at least one of: at least one sensor configured to collect information regarding the user, at least one sensor configured to collect information regarding the user's environment, and at least one virtual sensor configured to receive inputs from online services.

5. The method of claim 1, further comprising:
analyzing at least one feature included in the first dataset to determine a confidence level associated with the at least a routine information data feature.

6. The method of claim 5, wherein the at least one feature is any one of: an object identified near the user, an amount of people identified near the user, an identity of a person located near the user, a gesture made by the user, and an object located near the user.

7. The method of claim 6, wherein analyzing the first collected dataset further comprises:
applying at least one of: computer vision techniques, audio signal processing techniques, and machine learning techniques.

8. The method of claim 1, further comprising:
generating at least one question to determine the routine information of the user; and
updating the I/O device decision-making model of the digital assistant based on a user response to the at least one generated question.

9. The method of claim 1, wherein the confidence level defines the certainty that the routine information data feature is representative of the user's routines.

10. The method of claim 1, wherein the routine information data feature includes behavioral patterns, habits, and a routine schedule.

11. A non-transitory computer readable medium having stored thereon instructions for causing a processing circuitry to execute a process, the process comprising:
analyzing at least a first collected dataset to identify a routine information data feature and a confidence level associated with the routine information data feature, wherein the first collected dataset is a dataset associated with a user;
updating the input/output (I/O) device decision-making model of the digital assistant to include the identified routine information data feature; and
executing at least one plan via the updated digital assistant by causing the I/O device to output a signal for causing at least one action by an external system with respect to the outside world.

12. A system for updating an input/output device decision-making model of a digital assistant based on routine information of a user, comprising:
a processing circuitry; and
a memory, the memory containing instructions that, when executed by the processing circuitry, configure the system to:
analyze at least a first collected dataset to identify a routine information data feature and a confidence level associated with the routine information data feature, wherein the first collected dataset is a dataset associated with a user;
update the input/output (I/O) device decision-making model of the digital assistant to include the identified routine information data feature; and
execute at least one plan via the updated digital assistant by causing the I/O device to output a signal for causing at least one action by an external system with respect to the outside world.

13. The system of claim 12, wherein the system is further configured to:
determine whether the confidence level is above a threshold value.

14. The system of claim 13, wherein the input/output (I/O) device decision-making model of the digital assistant is updated to include the identified routine information data feature upon determination that the confidence level is above the threshold value.

15. The system of claim 12, wherein the system is further configured to:
collect the first collected dataset from at least one of: at least one sensor configured to collect information regarding the user, at least one sensor configured to collect information regarding the user's environment, and at least one virtual sensor configured to receive inputs from online services.

16. The system of claim 12, wherein the system is further configured to:
analyze at least one feature included in the first dataset to determine a confidence level associated with the at least a routine information data feature.

17. The system of claim 16, wherein the at least one feature is any one of: an object identified near the user, an amount of people identified near the user, an identity of a person located near the user, a gesture made by the user, and an object located near the user.

18. The system of claim 17, wherein the system is further configured to:
apply at least one of: computer vision techniques, audio signal processing techniques, and machine learning techniques.

19. The system of claim 12, wherein the system is further configured to:
generate at least one question to determine the routine information of the user; and
update the I/O device decision-making model of the digital assistant based on a user response to the at least one generated question.

20. The system of claim 12, wherein the confidence level defines the certainty that the routine information data feature is representative of the user's routines.

21. The system of claim 12, wherein the routine information data feature includes behavioral patterns, habits, and a routine schedule.
